(19) United States
(12) Patent Application Publication
(10) Pub. No.: US 2018/0107966 A1
(43) Pub. Date: Apr. 19, 2018

(54) SYSTEM AND METHOD FOR DIRECTING AN AUTOMOBILE MECHANIC TO A USER

(71) Applicant: Yousif Hadad, Shelby Township, MI (US)

(72) Inventor: Yousif Hadad, Shelby Township, MI (US)

(21) Appl. No.: 15/294,719

(22) Filed: Oct. 15, 2016

(51) Int. Cl. G06Q 10/06; H04L 29/08

(52) U.S. Cl. CPC G06Q 10/063118; H04L 67/18

(57) ABSTRACT

A system and computer implemented method for directing an automobile mechanic to a user comprises a memory unit to store a database comprising one or more records associated with at least one automobile mechanic, and a set of program modules. The system further comprises a processor to execute the set of program modules. The set of program modules comprises a location detection module, a mechanic availability module, a mechanic selection module, and a communication module. The mechanic availability module is configured to determine availability of the automobile mechanic in a vicinity of a location of the user. The mechanic selection module is configured to assign the automobile mechanic to the user. The communication module is configured to request the automobile mechanic to provide the repair service to the user, thereby directing at least one automobile mechanic to the user.

### BACKGROUND OF THE INVENTION

### A. Technical Field

The present invention generally relates to the technical field of non-social media website or mobile application or social media, and more specifically relates to a system and method for directing an automobile mechanic to a user.

### B. Description of Related Art

Social media websites and standard non-social media websites and mobile applications have pervaded every aspect of life in the twenty first century. Examples of the social media websites include but are not limited to RepairPal, Uber, Lyft, Facebook, LinkedIn, Meetup, and Tumblr. Examples of non-social media websites and mobile applications include but are not limited to Ebay, Amazon, Craigslist, Airbnb, Shipt, Jet, and KAYAK. Today, users access the social media websites, non-social media websites, and mobile applications for multiple purposes. As often is the case, users access the social media websites, non-social media websites, and mobile applications to acquire information about nearby restaurants, lodges, electronics showrooms, and car repair centers.

In an example, a social media website, or non-social media website, or mobile application directs a user to a car repair shop in the vicinity of the user. The user is thereby enabled to take a malfunctioning car to the car repair shop to have car repairs done. However, the social media website, or non-social media website, or mobile application as described in the example has a serious drawback. Often, the user lacks capability to take the malfunctioning car to the car repair shops especially if the malfunctioning car is the user's only mode of transport. As a result, the social media website, or non-social media website, or mobile application becomes redundant. For example, the social media website, or non-social media website, or mobile application as described in the present invention, becomes redundant if the user is stranded out on the road.

Therefore, there is a need in the art for a social media website, and or non-social media website, and or mobile application having a feature of directing an automobile mechanic to a user.

### SUMMARY OF THE INVENTION

The present invention relates to a system and method for directing an automobile mechanic to a user.

In one embodiment of the present invention, a system for directing an automobile mechanic to the user comprises a memory unit to store a database comprising one or more records associated with at least one automobile mechanic, and a set of program modules. The one or more records comprise information regarding location of at least one automobile mechanic. Further, the system comprises a processor to execute the set of program modules. The set of program modules comprises a location detection module, a mechanic availability module, a mechanic selection module, and a communication module. The location detection module is configured to determine a location of the user. The mechanic availability module is configured to determine availability of at least one automobile mechanic in a vicinity of the location. The mechanic selection module is configured to assign at least one automobile mechanic to the user based upon the availability of at least one automobile mechanic in the vicinity. The communication module is configured to transmit the location of the user to at least one automobile mechanic. The communication module is configured to request at least one automobile mechanic to provide at least one repair service to the user, thereby directing at least one automobile mechanic to the user.

In one embodiment of the present invention, the records further comprise a list of services offered by the plurality of automobile mechanics. In another embodiment of the present invention the list of services comprises at least one of a tire service, a window repair service, an engine repair service, a towing service, a brakes and suspension service and a basic oil service. In yet another embodiment of the present invention the location detection module determines the location of the user with a Global Positioning System (GPS).

In yet another embodiment of the present invention, the system further comprising an input module to receive at least one service request from the user. In yet another embodiment of the present invention the input module receives at least one service request in the form of at least one of a voice command, a text command and a gesture based command. In yet another embodiment of the present invention, the service request describes a repair service requested by the user. In yet another embodiment of the present invention the set of program modules are implemented as a network of Application Specific Integrated Circuit (ASIC) Chipsets in the system.

In one embodiment of the present invention, a computer implemented method of directing an automobile mechanic to a user, comprises storing one or more records associated with at least one automobile mechanic in a computer system. The one or more records comprise information regarding location of at least one automobile mechanic. Further, the method comprises determining a location of the user. Moreover, the method comprises determining availability of at least one automobile mechanic in a vicinity of the location of the user. Moreover, the method comprises assigning the automobile mechanic to the user, based upon the availability of the automobile mechanic in the vicinity. Moreover, the method comprises transmitting the location of the user to the automobile mechanic. Moreover, the method comprises requesting the automobile mechanic to provide the repair service to the user, thereby connecting the automobile mechanic to the user.

In yet another embodiment of the present invention, a non-transitory program storage device readable by computer, and comprising a program of instructions executable by a processor to perform a computer implemented method of directing an automobile mechanic to a user, comprises storing one or more records associated with at least one automobile mechanic in a computer system. The one or more records comprise information regarding location of at least one automobile mechanic. Further, the method comprises determining a location of the user. Moreover, the method comprises determining availability of at least one automobile mechanic in a vicinity of the location of the user. Moreover, the method comprises assigning at least one automobile mechanic to the user, based upon the availability of at least one automobile mechanic in the vicinity. Moreover, the method comprises transmitting the location of the user to at least one automobile mechanic. Moreover, the method comprises requesting at least one automobile mechanic to provide at least one repair service to the user, thereby connecting at least one automobile mechanic to the user.

### BRIEF DESCRIPTION OF DRAWINGS

FIG. 1 is a block diagram of an environment implemented in accordance with various embodiments of the invention.

FIG. 2 is a block diagram of a system for directing an automobile mechanic to a user, according to another embodiment of the present invention.

FIG. 3 is flow chart of a computer-implemented method of directing an automobile mechanic to a user, according to yet another embodiment of the present invention.

FIG. 4 is a screenshot view of a service request screen according to yet another embodiment of the present invention.

FIG. 5 is a screenshot view of an automobile mechanic screen according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

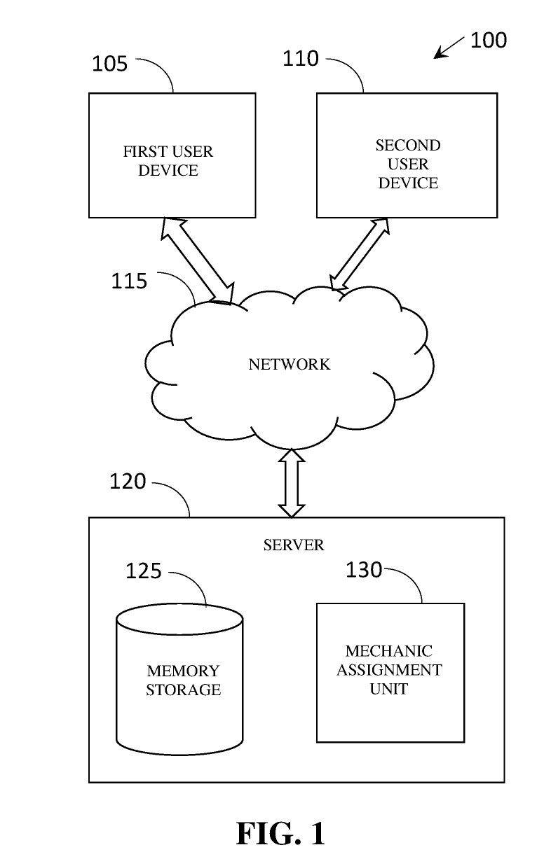

FIG. 1 is a block diagram of an environment 100 in accordance with which various embodiments of the present invention can be implemented. The environment 100 comprises a first user device 105, a second user device 110, a network 115, and a server 120. The first user device 105 and the second user device 110 are at least one of laptops, personal computers, smart phones, smart televisions, tablet computers, smart watches, smart glasses and virtual reality glasses, vehicle infotainment systems for standard and autonomous vehicles. In one embodiment of the present invention, the first user device 105 and the second user device 110 comprises a global positioning system (GPS). In one example, the first user device 105 enables a user to communicate with the server 120 via the network 115. In another example, the second user device 110 enable at least one automobile mechanic to communicate with the server 120 via the network 115. The network 115 is at least one of a mobile network, a wide area network and a wireless radio network. The server 120 is at least one of a file server, a database server, a communications server, an applications server, a cloud server, and a domain server. The server 120 comprises a mechanic assignment unit 130 and a memory unit 125. The memory unit 125 is at least one of a flash memory, magnetic tapes, optical discs, and floppy discs. The memory unit 125 comprises a database of one or more records. The records comprise at least one of names, and lists of services offered by a plurality of automobile mechanics registered with the server 120. The list of services provided comprise at least one of a tire service, a window repair service, an engine repair service, a towing service, a brakes and suspension service and a basic service. Further, the memory unit 125 comprises a set of program modules, executable by a processor. The set of program modules comprises an input module, a location detection module, a mechanic availability module, a mechanic selection module, and a communication module. In one embodiment of the present invention, functionality of the set of program modules is implemented in a network of corresponding Application Specific Integrated Circuit (ASIC) Chipsets.

Further, the mechanic assignment unit 130 is at least one of a Field Programmable Gate Array, a microprocessor, an Application Specific Integrated Circuit, a virtual machine, an interconnection of digital logic gates, a microcontroller, a microprocessor, a mainframe data processor, and a multicore processor. The mechanic assignment unit 130 is configured to execute program modules stored in the memory unit 125. In one exemplary illustration of functioning of the present invention, the mechanic assignment unit 130 directs at least one automobile mechanic to the user by executing the set of program modules stored in the memory unit 125. In one embodiment, the present invention is implemented in a website. In another embodiment, the present invention is implemented in a social media website. In another embodiment, the present invention is implemented in a mobile application. In yet another embodiment, the present invention is implemented in a server. In yet another embodiment, the present invention is implemented in a search engine.

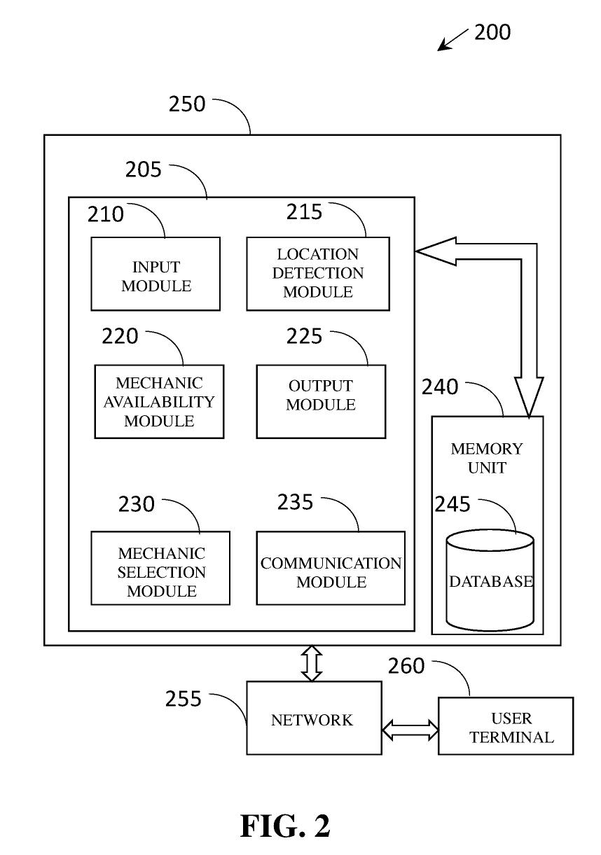

FIG. 2 is a block diagram of a system 200 for directing an automobile mechanic to a user, according to another embodiment of the present invention. The system 200 is implemented inside a device 250 connected to a network 255. In one embodiment of the present invention, the device 250 is a server. In another embodiment of the present invention, the device 250 is at least one of a smart watch, a smart glass and a virtual reality glass, a vehicle infotainment system for standard and autonomous vehicles, a laptop, a personal computer, a smart phone, a smart television, and a tablet computer. The network 255 is at least one of a Local Area Network, a Wide Area Network, a Wireless Network, a telecommunication network, a mobile network, and Internet. The network 255 enables the user to communicate with the device 250. The user is connected to the network 255 via a user terminal 260. The user terminal 260 is at least one of a smart watch, a smart glass, a virtual reality glass, a vehicle infotainment system for standard and autonomous vehicles, a laptop, a personal computer, a smart phone, a smart television, and a tablet computer. The user terminal 260 comprises a global positioning system.

Further, the device 250 comprises a memory unit 240 and a mechanic assignment unit 205. The memory unit 240 is at least one of a volatile memory, non-volatile memory, Read Only memory (ROM), Random Access Memory (RAM), and a flash memory. The memory unit 240 comprises a database 245 of one or more records. The records comprise at least one of names, locations of a plurality of automobile mechanics registered with the system 200 as well as a list of services offered by the plurality of automobile mechanics. The plurality of automobile mechanics are connected to the system 200 via a plurality of electronic devices. The plurality of electronic devices comprise laptops, personal computers, smart phones, smart televisions, tablet computers, smart watches, smart glasses and virtual reality glasses, vehicle infotainment systems for standard and autonomous vehicles. The list of services provided comprise at least one of a tire service, a window repair service, an engine repair service, a towing service, a brakes and suspension service and a basic oil service. The memory unit 240 transmits the records to the mechanic assignment unit 205.

The mechanic assignment unit 205 is at least one of a processor, a Field Programmable Gate Array, a microprocessor, an Application Specific Integrated Circuit, a virtual machine, and an interconnection of digital logic gates. The mechanic assignment unit 205 executes a set of program modules. The set of program modules comprises an input module 210, a location detection module 215, a mechanic availability module 220, a mechanic selection module 230, an output module 225, and a communication module 235. In one embodiment of the present invention, source code for the set of program modules is stored in the memory unit 240. In another embodiment of the present invention, functionality of the set of program modules is implemented in a network of corresponding Application Specific Integrated Circuit (ASIC) Chipsets configured inside the mechanic assignment unit 205.

The input module 210 is configured to receive information about the user. In one embodiment of the present invention, information about the user pertains to at least one of name of the user, and at least one service request of the user. At least one service request describes a repair service requested by the user. Examples of the repair service needed by the user include, but is not limited to a request for a tire service, a window repair service, an engine repair service, a towing service, a brakes and suspension service and a basic service. In one embodiment of the present invention, the input module 210 receives information about the user via an input component of the device 250. An example of the input component includes but is not limited to a microphone, a keyboard, a mouse pointer, and a video camera. The input module 210 receives information about the user in the form of at least one of a voice command, text command, a gesture based command and a mouse-click. The input module 210 transmits the information about the user into the location detection module 215.

In one embodiment of the present invention, the location detection module 215 is implemented in Application Specific Integrated Circuit Chip. The location detection module 215 communicates with the GPS module (not shown) of the user terminal 260 via the output module 225. Further, the location detection module 215 receives one or more data items from the GPS module and determines a location of the user based upon the one or more data items. The one or more data items comprise information regarding coordinates of the user in accordance with one of a radial, linear and cartographical system. The output module 225 controls at least one of a radio transceiver, a Global System for Mobile (GSM) communication transceiver and a broadband modem. The location detection module 215 transmits information regarding the location of the user to the mechanic availability module 220.

In one embodiment of the present invention, the mechanic availability module 220 is implemented in Application Specific Integrated Circuit Chip. The mechanic availability module 220 analyses the records associated with the plurality of automobile mechanics. It is noted that the records comprises locations of the plurality of automobile mechanics. Further, the mechanic availability module 220 selects at least one automobile mechanic from the plurality of automobile mechanics based upon the automobile mechanic being in vicinity of the location of the user. Further, the mechanic availability module 220 analyses one or more records associated with the automobile mechanic. If the repair service needed by the user is among the list of services offered by the automobile mechanic, then the mechanic availability module 220 transmits the records associated with the automobile mechanic to the mechanic selection module 230.

The mechanic selection module 230 assigns the automobile mechanic to the user. Further, the mechanic selection module 230 transmits the records associated with the automobile mechanic to the communication module 235. In one example, the mechanic selection module 230 requests a confirmation message from the user prior to assigning the automobile mechanic to the user. The user is enabled to provide the confirmation message as one of a text message, email, and a voice command

The communication module 235 transmits the location of the user to at least one electronic device among the plurality of electronic devices associated with the automobile mechanic. In one example, the communication module 235 further transmits a notification regarding the confirmation from the user. Moreover, the communication module 235 requests the user to make a payment for the repair service described in at least one service request. The payment comprises expenses for performing the repair service. Examples of the expenses include service charge, tip, and cost of replacement parts. The communication module 235 transmits the notifications and requests as at least one of a text message, a voice message and an electronic mail. Further, the communication module 235 transmits an invoice to the user and the automobile mechanic.

The electronic device is associated with the automobile mechanic. Further, the communication module 235 transmits at least one service request to the electronic device. Further, communication module 235 requests the automobile mechanic to perform the repair service as described by at least one service request, thereby directing the automobile mechanic to the user.

In one embodiment of the present invention, the system 200 enables the user to evaluate and rate the automobile mechanic based on the repair service done by the automobile mechanic. The user rates the automobile mechanic by providing at least one of a star rating, a badge, an award and a written testimony. Further, the system 200 enables the automobile mechanic to evaluate and rate the user. The automobile mechanic rates the user by providing at least one of a star rating, a badge, an award and a written testimony. Further, the system 200 enables the user and the plurality of automobile mechanic to form business groups. The system 200 enables the user to one of add and remove at least one automobile mechanic from the social group.

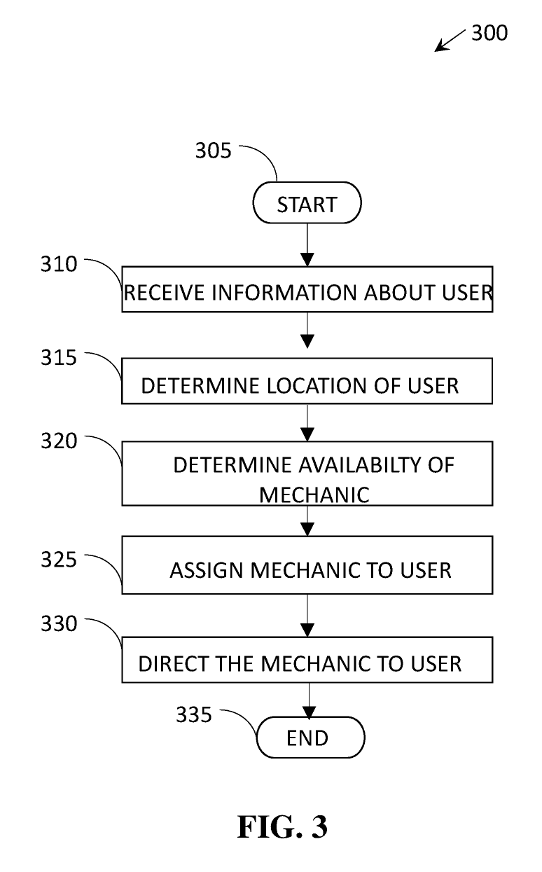

FIG. 3 is flow chart illustrating a computer-implemented method 300 of directing an automobile mechanic to a user, according to yet another embodiment of the present invention. The method 300 is implemented in a computer system comprising a memory unit and a processor. The memory unit stores a database comprising one or more records associated with a plurality of automobile mechanics. The records comprise at least one of names, locations of a plurality of automobile mechanics as well as a list of services offered by the plurality of automobile mechanics. The plurality of automobile mechanics are connected to a plurality of electronic devices. The plurality of electronic devices comprise laptops, personal computers, smart phones, smart televisions, tablet computers, smart watches, smart glasses and virtual reality glasses, vehicle infotainment systems for standard and autonomous vehicles. The list of services provided comprise at least one of a tire service, a window repair service, an engine repair service, a towing service, a brakes and suspension service, and a basic oil service. It is noted that a plurality of electronic devices, comprising smart watches, smart glasses, virtual reality glasses, vehicle infotainment systems for standard and autonomous vehicles, tablet computers, mobile phones and laptops are associated with each of the plurality of automobile mechanics. The plurality of electronic devices comprise Global Positioning System (GPS) modules. Further, the memory unit stores a set of program modules. Moreover, the computer system comprises a processor. The method 300 commences at step 305.

At step 310, information about the user is received at an input module executed by the processor. In one embodiment of the present invention, information about the user pertains to at least one of name of the user, and at least one service request by the user. At least one service request describes a repair service requested by the user. An example of the repair service needed by the user includes, but is not limited to a request for a tire service, a window repair service, an engine repair service, a towing service, a brakes and suspension service and a basic service.

At step 315, a location of the user is determines at a location detection module executed by the processor. In one embodiment of the present invention, the location detection module is implemented in Application Specific Integrated Circuit Chip. The location detection module communicates with a GPS module of a user terminal of the user. Further, the location detection module receives one or more data items from the GPS module and determines the location of the user based upon the one or more data items. The one or more data items comprise information regarding coordinates of the user in accordance with one of a radial, linear and cartographical system.

At step 320, availability of the automobile mechanic is determined by a mechanic availability module executed by the processor. The mechanic availability module analyses the records associated with the plurality of automobile mechanics. It is noted that the records comprises locations of the plurality of automobile mechanics. Further, the mechanic availability module selects at least one automobile mechanic from the plurality of automobile mechanics based upon the automobile mechanic being in vicinity of the location of the user. Moreover, the mechanic availability module analyses one or more records associated with the automobile mechanic. If the repair service needed by the user is among the list of services offered by the automobile mechanic, then the mechanic availability module determines the automobile mechanic to be available.

At step 325, the automobile mechanic is assigned to the user by a mechanic selection module.

At step 330 the automobile mechanic is directed to the user by a communication module executed by the processor. To direct the automobile mechanic to the user, the communication module transmits the location of the user to at least one electronic device among the plurality of electronic devices. The electronic device is associated with the automobile mechanic. Further, the communication module transmits at least one service request to the electronic device. Further, the communication module requests the automobile mechanic to perform the repair service as described by at least one service request, thereby directing the automobile mechanic to the user.

The method 300 ends at step 335.

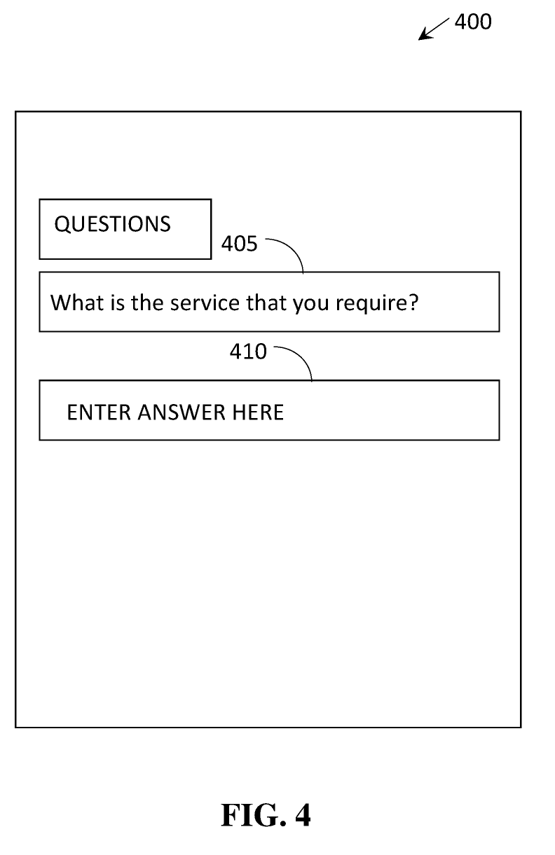

FIG. 4 is a screenshot view of a service request screen 400 according to yet another embodiment of the present invention. The service request screen 400 comprises a question box 405 and an answer box 410. The question box 405 displays a question directed towards at least one user. In one example, the question is “What service do you require?”. The service request screen 400 invites at least one user to input a service request in the answer text box 410.

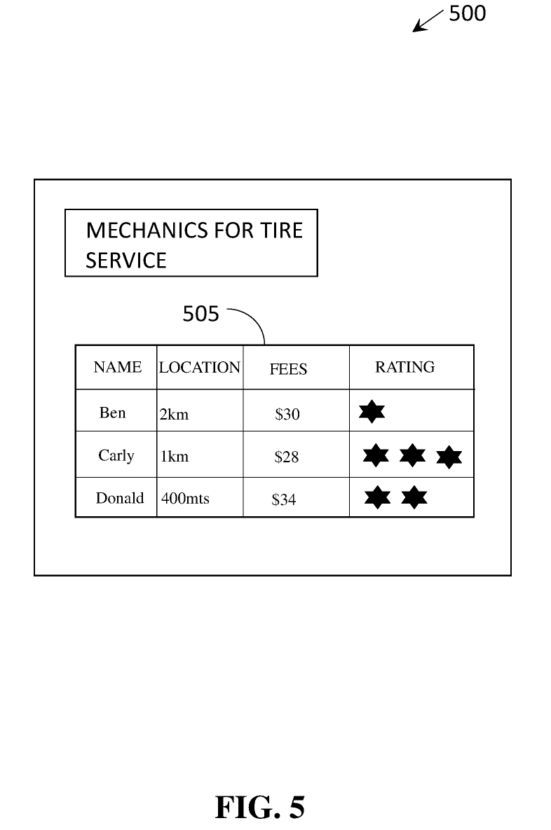

FIG. 5 is a screenshot view of an automobile mechanic screen 500 according to yet another embodiment of the present invention. The automobile mechanic screen 500 comprises a table 505 as displayed to a user. The table 505 comprises information about a plurality of automobile mechanics assigned by a mechanic selection module. The information comprises location of the plurality of automobile mechanic, fees charged by the plurality of automobile mechanics, and rating of the plurality of automobile mechanics. In one example, the user is enabled to select at least one automobile mechanic from the table 505. A communication module executed by the processor directs at least one automobile mechanic to the user.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for directing an automobile mechanic to a user, the system comprising:
a memory unit to store:
a database comprising one or more records associated with at least one automobile mechanic, and
a set of program modules,
wherein the one or more records comprise information regarding location of at least one automobile mechanic;
a processor to execute the set of program modules, wherein the set of program modules comprise:
a location detection module, executed by the processor, configured to determine a location of the user;
a mechanic availability module, executed by the processor, configured to determine availability of at least one automobile mechanic in a vicinity of the location;
a mechanic selection module, executed by the processor, configured to assign at least one automobile mechanic to the user, based on the availability of at least one automobile mechanic in the vicinity; and
a communication module, executed by the processor, configured to:
transmit the location of the user to at least one automobile mechanic, and
request at least one automobile mechanic to provide at least one repair service to the user, thereby directing at least one automobile mechanic to the user.

2. The system of claim 1, wherein the one or more records further comprises a list of services offered by at least one automobile mechanic.

3. The system of claim 2, wherein the list of services comprises at least one of a tire service, a window repair service, an engine repair service, a towing service, a brakes and a suspension service, and an oil service.

4. The system of claim 1, wherein the location detection module determines the location of the user with a Global Positioning System (GPS).

5. The system of claim 1, further comprising an input module to receive at least one service request from the user.

6. The system of claim 5, wherein the input module receives at least one service request as at least one of a voice command, a text command and a gesture based command

7. The system of claim 5, wherein at least one service request is to perform a repair service requested by the user.

8. The system of claim 1, wherein the set of program modules are implemented in a network of Application Specific Integrated Circuit (ASIC) Chipsets in the system.

9. A computer implemented method of directing an automobile mechanic to a user, comprising:
storing one or more records associated with at least one automobile mechanic in a computer system, wherein the one or more records comprise information regarding location of at least one automobile mechanic;
determining, at a processor, a location of the user, with a location detector module;
determining at a processor via a mechanic availability module, availability of at least one automobile mechanic in a vicinity of the location of the user;
assigning by a processor via a mechanic selection module, at least one automobile mechanic to the user, based on the availability of at least one automobile mechanic in the vicinity;
transmitting by a processor via the communication module, the location of the user to at least one automobile mechanic; and
requesting by a processor via the communication module, at least one automobile mechanic to provide at least one repair service to the user, thereby connecting at least one automobile mechanic to the user.

10. The method of claim 9, wherein the one or more records further comprise a list of services offered by at least one automobile mechanic.

11. The method of claim 9, wherein the list of services comprises at least one of a tire service, a window repair service, an engine repair service, a towing service, a brakes and suspension service and an oil service.

12. The method of claim 9, wherein the location detection module determines the location of the user with a Global Positioning System (GPS).

13. The method of claim 9, further comprising an input module to receive at least one service request from the user.

14. The method of claim 13, wherein the input module receives at least one service request in at least one of a voice command, text command and a gesture based command.

15. The method of claim 13, wherein at least one service request is to perform a repair service requested by the user.

16. The method of claim 9, wherein the set of program modules are implemented in a network of Application Specific Integrated Circuit (ASIC) Chipsets in the system.

17. A non-transitory program storage device readable by computer, and comprising a program of instructions executable by a processor to perform a computer implemented method of directing an automobile mechanic to a user, comprising:
storing one or more records associated with at least one automobile mechanic in a computer system, wherein the one or more records comprise information regarding location of at least one automobile mechanic;
determining, by a processor, a location of the user;
determining, by a processor, availability of at least one automobile mechanic in a vicinity of the location of the user;
assigning, by a processor, at least one automobile mechanic to the user, based upon the availability of at least one automobile mechanic in the vicinity;
transmitting, by a processor, the location of the user to at least one automobile mechanic; and
requesting, by a processor, at least one automobile mechanic to provide at least one repair service to the user, thereby connecting at least one automobile mechanic to the user.
